(19) United States
(12) Patent Application Publication
(10) Pub. No.: US 2026/0192197 A1
(43) Pub. Date: Jul. 9, 2026

(54) AVATAR CONVERSION SYSTEM, AVATAR CONVERSION SERVER, AVATAR CONVERSION PROGRAM, AND AVATAR CONVERSION METHOD

(71) Applicant: Sony Interactive Entertainment Inc., Tokyo (JP)

(72) Inventors: YASUNORI MATSUI, Tokyo (JP); Hiroshi Morita, Kanagawa (JP); Ryota Murasugi, Chiba (JP)

(73) Assignee: Sony Interactive Entertainment Inc., Tokyo (JP)

(21) Appl. No.: 19/131,936

(22) PCT Filed: Dec. 12, 2022
(86) PCT No.: PCT/JP2022/045685

§ 371 Date: May 21, 2025

(51) Int. Cl. A63F 13/52; A63F 13/355; G06T 19/20

(52) U.S. Cl. CPC A63F 13/52; G06T 19/20; A63F 13/355; A63F 2300/8082; G06T 2219/2012; G06T 2219/2024

(57) ABSTRACT

An avatar conversion system capable of avatar conversion according to a world view of a transfer destination is provided. The avatar conversion system includes a user terminal including a first virtual space providing program execution section that uses a first avatar generated on the basis of first avatar data in a first virtual space, a second virtual space providing program execution section, and a conversion request section that generates a conversion request signal for requesting conversion from the first avatar to a second avatar; and an avatar conversion server including a conversion information storage section that stores previously set conversion information regarding the first avatar data and second avatar data, and an avatar conversion section that generates the second avatar data from the first avatar data on the basis of the conversion information when the conversion request signal has been acquired, in which the second avatar is generated on the basis of the second avatar data acquired from the avatar conversion server in accordance with a user operation.

### TECHNICAL FIELD

The present invention relates to an avatar conversion system, an avatar conversion server, an avatar conversion program, and an avatar conversion method.

### BACKGROUND ART

Virtual reality technology is a technology for enabling a person to view and experience a virtual space constructed on a computer as if the virtual space were real. For example, in a game that uses the virtual reality technology, a user operates a virtual character called an avatar in a virtual space, thereby causing the game to progress.

In recent years, a plurality of business entities have been offering a variety of virtual spaces constructed thereby to users. Some users who execute a plurality of applications desire to use an avatar of the same character in different virtual spaces. For example, PTL 1 below discloses a method for transferring avatar data between computer systems that construct different virtual spaces.

### CITATION LIST

### Patent Literature

[PTL 1] JP 2014-529792T

### SUMMARY

### Technical Problem

In each of applications that use the virtual reality technology, a virtual space is constructed according to a world view of that application. Accordingly, in the case where an avatar used in one virtual space is transferred to another virtual space with no change made to the avatar, the appearance of the avatar may be incongruous with a world view of the virtual space at the transfer destination.

The present invention has been conceived in view of the above, and an object thereof is to provide an avatar conversion system, an avatar conversion server, and an avatar conversion program which are capable of avatar conversion according to a world view of a transfer destination.

### Solution to Problem

(1) To solve the above problem, an avatar conversion system according to one implementation of the present disclosure is an avatar conversion system including a user terminal including a first virtual space providing program execution section that uses a first avatar generated on the basis of first avatar data in a first virtual space, a second virtual space providing program execution section that uses a second avatar generated on the basis of second avatar data in a second virtual space, and a conversion request section that generates a conversion request signal for requesting conversion from the first avatar to the second avatar on the basis of an instruction from a user, and an avatar conversion server including a conversion information storage section that previously stores set conversion information regarding the first avatar data and the second avatar data, and an avatar conversion section that, when the conversion request signal has been acquired, acquires the first avatar data from the user terminal, and generates the second avatar data from the first avatar data on the basis of the conversion information stored in the conversion information storage section, in which the second avatar is generated on the basis of the second avatar data acquired from the avatar conversion server in accordance with a user operation.
(2) In this implementation, the avatar conversion system further include an access key generation section that generates an access key associated with the second avatar when the avatar conversion section has generated the second avatar data from the first avatar data, in which the second virtual space providing program execution section acquires the second avatar data from the avatar conversion server in response to an input of the access key by the user.
(3) In this implementation, the avatar conversion system further include a management server including a policy notification section that notifies the user terminal of policy information related to the conversion from the first avatar to the second avatar when the conversion request signal has been acquired.
(4) In this implementation, the policy information include information indicating whether or not modification of appearance is permitted when the first avatar is converted to the second avatar.
(5) In this implementation, the policy information include information indicating whether or not a user different from the user who has issued the instruction is permitted to copy the second avatar in the second virtual space.
(6) In this implementation, each of the first avatar data and the second avatar data include character base data including bone information and motion information thereof, and appearance data regarding each of portions of an avatar, and the conversion information may be information indicating previously set correspondences between the character base data and the appearance data regarding each portion included in the first avatar data and the character base data and the appearance data regarding each portion included in the second avatar data.
(7) In this implementation, the first virtual space providing program execution section may be a program for executing a game with the first avatar being caused to move in the first virtual space, and the second virtual space providing program execution section may be a program for executing a game with the second avatar being caused to move in the second virtual space.
(8) An avatar conversion server according to another aspect of the present disclosure is an avatar conversion server that performs conversion of an avatar when a conversion request signal has been acquired from a user terminal including a first virtual space providing program execution section that uses a first avatar generated on the basis of first avatar data in a first virtual space, a second virtual space providing program execution section that uses a second avatar generated on the basis of second avatar data in a second virtual space, and a conversion request section that generates a conversion request signal for requesting conversion from the first avatar to the second avatar on the basis of an instruction from a user, the avatar conversion server including a conversion information storage section that stores previously set conversion information regarding the first avatar data and the second avatar data, and an avatar conversion section that, when the conversion request signal has been acquired, acquires the first avatar data from the user terminal, and generates the second avatar data from the first avatar data on the basis of the conversion information stored in the conversion information storage section, in which the second avatar is generated on the basis of the second avatar data acquired from the avatar conversion server in accordance with a user operation.
(9) An avatar conversion program according to another aspect of the present disclosure causes a computer to perform a step of acquiring, from a user terminal including a first virtual space providing program execution section that uses a first avatar generated on the basis of first avatar data in a first virtual space, a second virtual space providing program execution section that uses a second avatar generated on the basis of second avatar data in a second virtual space, and a conversion request section that generates a conversion request signal for requesting conversion from the first avatar to the second avatar on the basis of an instruction from a user, the conversion request signal, a step of acquiring the first avatar data from the user terminal when the conversion request signal has been acquired, and an avatar conversion step of generating the second avatar data from the first avatar data on the basis of previously set conversion information regarding the first avatar data and the second avatar data stored conversion information storage section that stores the conversion information, in which the second avatar is generated on the basis of the second avatar data generated in the avatar conversion step in accordance with a user operation.
(10) An avatar conversion method according to another aspect of the present disclosure includes a step of acquiring, from a user terminal including a first virtual space providing program execution section that uses a first avatar generated on the basis of first avatar data in a first virtual space, a second virtual space providing program execution section that uses a second avatar generated on the basis of second avatar data in a second virtual space, and a conversion request section that generates a conversion request signal for requesting conversion from the first avatar to the second avatar on the basis of an instruction from a user, the conversion request signal, a step of acquiring the first avatar data from the user terminal when the conversion request signal has been acquired, and an avatar conversion step of generating the second avatar data from the first avatar data on the basis of previously set conversion information regarding the first avatar data and the second avatar data stored in a conversion information storage section that stores the conversion information, in which the second avatar is generated on the basis of the second avatar data generated in the avatar conversion step in accordance with a user operation.

### BRIEF DESCRIPTION OF DRAWINGS

FIG. 1 is a diagram illustrating an example of an avatar conversion system according to an embodiment of the present disclosure.

FIG. 2 is a diagram illustrating an example of a hardware configuration of a user terminal.

FIG. 3 is a functional block diagram for explaining functions of the user terminal.

FIG. 4 represents diagrams each illustrating an example of user information.

FIG. 5 is a diagram illustrating an example of first avatar data.

FIG. 6 is a diagram illustrating an example appearance of a first avatar.

FIG. 7 represents a functional block diagram of each of a management server, a policy server, and an avatar conversion server.

FIG. 8 is a diagram illustrating an example of a policy table.

FIG. 9 represents an example illustrating conversion information regarding a first virtual space and a second virtual space.

FIG. 10 is a diagram illustrating an example of second avatar data.

FIG. 11 is a diagram illustrating an example appearance of a second avatar.

FIG. 12 is a flowchart illustrating an example of an avatar conversion procedure.

### DESCRIPTION OF EMBODIMENT

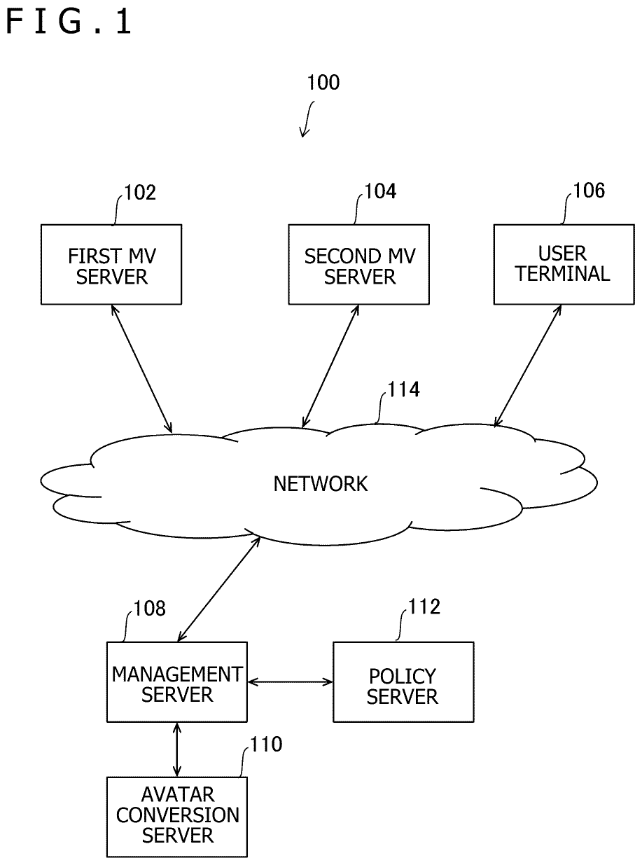

FIG. 1 is a diagram illustrating an example of an avatar conversion system according to the present embodiment. The avatar conversion system 100 includes a first MV (Metaverse) server 102, a second MV server 104, a user terminal 106, a management server 108, an avatar conversion server 110, and a policy server 112, and these components are connected through a network 114. Note that, although two MV servers and one user terminal 106 are depicted in FIG. 1, the number of MV servers and the number of user terminals 106 may be two or more.

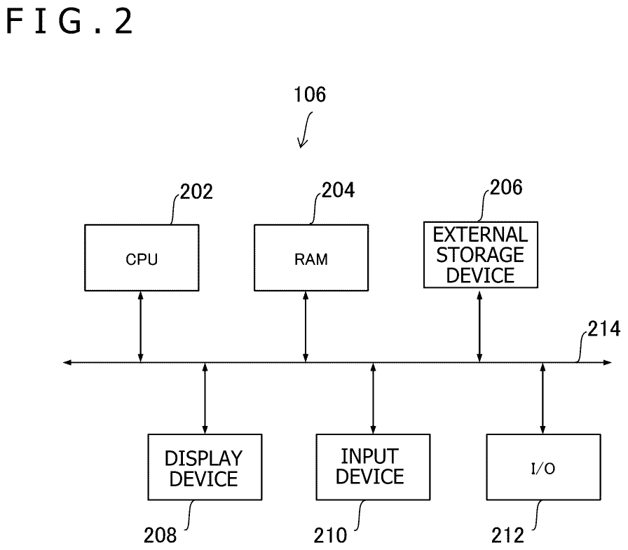

The first MV server 102 is a server that transmits, to the user terminal 106, data related to a content that provides a user with an experience of a virtual space. Specifically, the first MV server 102, for example, has an external storage device (see FIG. 2) in which a first virtual space providing program is stored. The first virtual space providing program is a program that uses a first avatar generated on the basis of first avatar data in a first virtual space. For example, the first virtual space providing program causes a game to progress with the first avatar generated on the basis of the first avatar data being caused to move in the first virtual space. Avatar data and user identification data of each of users may be stored in the external storage device. The first MV server 102 transmits the first virtual space providing program in response to a request transmitted from the user terminal 106. Note that it is assumed hereinafter that the term “user” without any adjective refers to a user who operates the user terminal 106, and the term “other users” refers to users who operate other user terminals not depicted. It is also assumed that the first virtual space is a virtual space having a realistic world view in which humans, robots, etc., which are eight heads tall are placed.

In addition, when the first virtual space providing program is being executed in the user terminal 106, the first MV server 102 delivers information related to an avatar of each of users in the first virtual space to user terminals 106 of other users. Specifically, when a plurality of user terminals 106 are executing the first virtual space providing program in parallel, for example, a plurality of avatars exist in the first virtual space. In this case, when one user terminal 106 executes the first virtual space providing program, information (information such as the positions, postures, etc., of the avatars in the first virtual space) related to the avatars of the other users is required. The first MV server 102 acquires, from each of the user terminals, information related to the corresponding avatar, and delivers the information to all other user terminals. Note that, in order to reduce a load, the first MV server 102 may acquire, from some of the user terminals (users related to avatars that are displayed in the same screen among all users), the information related to the corresponding avatars, and deliver the information to some of the other user terminals.

Similarly to the first MV server 102, the second MV server 104 is a server that transmits, to the user terminal 106, data related to a content that provides the user with an experience of a virtual space. Specifically, the second MV server 104 has an external storage device (see FIG. 2) in which a second virtual space providing program is stored. The second virtual space providing program is a program that uses a second avatar generated on the basis of second avatar data in a second virtual space. For example, the second virtual space providing program causes a game to progress with the second avatar generated on the basis of the second avatar data being caused to move in the second virtual space. It is assumed hereinafter that the second virtual space is a virtual space having an anime-style world view in which humans, robots, etc., which are two heads tall are placed.

Note that each of the first virtual space providing program and the second virtual space providing program is a program that provides a virtual space related to a game in the above example, but may alternatively be a program that provides a virtual space related to another type of content. For example, each of the first virtual space providing program and the second virtual space providing program may provide an experience of a virtual space reproducing a live performance venue of a musician, or of a virtual space reproducing a conference room for an online meeting.

In addition, the present embodiment may be an implementation in which each of the user terminals acquires (i.e., downloads) neither of the first virtual space providing program and the second virtual space providing program. In this case, each of the MV servers has a corresponding virtual space providing program execution section (which will be described below). In addition, each MV server may execute the virtual space providing program stored in the MV server, and deliver image data to each user terminal in a streaming manner.

The user terminal 106 causes the user to view and experience a virtual space constructed on a computer as if the virtual space were real. The details of the user terminal 106 will be described below.

The management server 108 stores information related to the users. In addition, the management server 108 transmits and receives various types of data to and from the user terminal 106, the policy server 112, the avatar conversion server 110, and the user terminal 106. The avatar conversion server 110 performs conversion of avatars. The policy server 112 stores policy information related to the conversion of avatars. The management server 108, the avatar conversion server 110, and the policy server 112 will be described in detail below.

FIG. 2 is a diagram illustrating an example of a hardware configuration of the user terminal 106. The user terminal 106 is a common computer that includes a CPU 202 (Central Processing Unit), which is a processor, a RAM 204 (Random Access Memory), which is a memory, an external storage device 206, a display device 208, an input device 210, and an I/O 212 (Input/Output), these components being connected via a data bus 214 such that electrical signals can be exchanged therebetween. Note that the hardware configuration of the user terminal 106 presented here is a mere example, and that another configuration may alternatively be adopted. The user terminal 106 is, for example, a stationary game machine placed in a home of the user, a hand-held game machine, or a smartphone.

The external storage device 206 is a device capable of statically storing information, such as an HDD (Hard Disk Drive) or an SSD (Solid State Drive). The display device 208 is a CRT (Cathode Ray Tube), a generally-called flat-panel display, or the like, and displays images. The input device 210 is one or a plurality of devices for information input by the user, such as a game controller, a keyboard, a mouse, a touch panel, and/or the like. The I/O 212 is one or a plurality of interfaces for information exchange between the computer and external devices. The I/O 212 may include various types of ports for wired connection, and a controller for wireless connection.

A program for causing the computer to function as the user terminal 106 is stored in the external storage device 206, and is loaded into the RAM 204 and executed by the CPU 202 as necessary. That is, as a result of the program being executed by the CPU 202, codes for implementing various functions depicted as functional blocks in FIG. 2 is stored in the RAM 204. This program may be stored in a computer-readable information storage medium, such as an optical disk, a magneto-optical disk, or a flash memory, and provided therethrough, or may be provided through an external information communication channel, such as the Internet, via the I/O 212.

The hardware configuration of each of the servers will be described below with reference to FIG. 2 as is the case with the user terminal 106. The hardware configuration of each of the servers (i.e., the first MV server 102, the second MV server 104, the management server 108, the policy server 112, and the avatar conversion server 110) may be, for example, the same as the hardware configuration of the user terminal 106 described above.

As illustrated in FIG. 2, each server includes a CPU, a RAM, an external storage device, a display device, an input device, and an I/O, and these components are connected via a data bus such that electrical signals can be exchanged therebetween. Each server is a common computer. The constituent hardware elements included in each server are similar to the respective constituent elements included in the user terminal 106. In the external storage device included in each server, a program for causing a computer to function as the server is stored, and the program is loaded into the RAM and executed by the CPU as necessary. For example, an avatar conversion program for causing a computer to function as the avatar conversion server is stored in the external storage device of the avatar conversion server, and is loaded into the RAM and executed by the CPU as necessary.

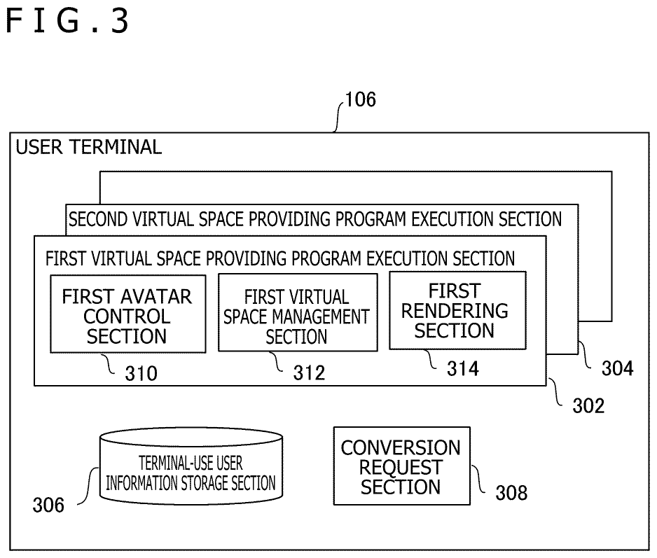

FIG. 3 is a functional block diagram for explaining functions of the user terminal 106. As illustrated in FIG. 3, the user terminal 106 functionally includes a first virtual space providing program execution section 302, a second virtual space providing program execution section 304, a terminal-use user information storage section 306, and a conversion request section 308.

The first virtual space providing program execution section 302 executes the first virtual space providing program. The first virtual space providing program is, for example, a program that causes a game to progress with the first avatar generated on the basis of the first avatar data (which will be described below) being caused to move in the first virtual space. The first virtual space program execution section 302 functionally includes a first avatar control section 310, a first virtual space management section 312, and a first rendering section 314.

The first avatar control section 310 generates the first avatar on the basis of the first avatar data stored in the terminal-use user information storage section 306, and places the first avatar in the first virtual space.

In addition, the first avatar control section 310 controls motion of the first avatar in the first virtual space.

Specifically, for example, the input device 210, such as a controller, accepts a user operation, and accordingly generates operation data. The first avatar control section 310 generates control data for the posture and position of the first avatar on the basis of the operation data, and controls the position and posture of the first avatar in the first virtual space.

The first virtual space management section 312 manages data regarding objects existing within the first virtual space. Specifically, examples of the data regarding objects include model data and position data of the objects. The first avatar is one of the objects existing within the first virtual space. Examples of data related to the first avatar include the first avatar data and control data. Data regarding the first virtual space has been acquired (downloaded) by the user terminal 106 from the first MV server 102 in advance, and stored in an auxiliary storage device. The first virtual space management section 312 constructs the first virtual space on the basis of the data regarding the objects existing within the first virtual space, and places the first avatar in the first virtual space.

In addition, in the case where another user terminal 106 is executing the first virtual space providing program, the first virtual space management section 312 acquires avatar data and control data related to an avatar of another user (hereinafter referred to as “other's avatar”) through the first MV server 102. Then, the first virtual space management section 312 applies, to the other's avatar, the control data related to the other's avatar received from the user terminal of the other user.

In addition, if there is any object moving within the first virtual space, the first virtual space management section 312 updates the posture and position of that object according to the movement thereof. The data regarding the first virtual space is managed such that synchronization is maintained between the user terminals 106, with the result that the first virtual space managed by each user terminal 106 is an identical virtual space. Any one of the user terminals 106 may manage the first virtual space, or the first MV server 102 may manage the first virtual space. In the case where a specific device manages the first virtual space, each user terminal 106 acquires the data regarding the first virtual space from that device.

The first rendering section 314 renders the first virtual space as viewed from a prescribed viewpoint, and supplies image data obtained by the rendering to a display section. Specifically, the first rendering section 314 renders the first virtual space as viewed from a viewpoint of the first avatar, for example. In addition, the first rendering section 314 may perform rendering with the viewpoint placed at a position from which the first avatar can be overlooked. The image data generated by the rendering is supplied to the display section, so that the display section displays the image data.

The second virtual space providing program execution section 304 executes the second virtual space providing program. The second virtual space providing program is, for example, a program that causes a game to progress with the second avatar generated on the basis of the first avatar data being caused to move in the second virtual space. The second virtual space providing program execution section 304 functionally includes a second avatar control section, a second virtual space management section, and a second rendering section. Here, the second virtual space providing program is a program of a game different from that of the first virtual space providing program, and functions of the sections included in the second virtual space providing program execution section 304 are similar to the functions of the sections included in the first virtual space providing program execution section 302.

In addition, in response to an input of an access key by the user, the second virtual space providing program execution section 304 acquires the second avatar data from the avatar conversion server 110. The second virtual space providing program execution section 304 causes the game to progress with the second avatar generated on the basis of the acquired second avatar data being caused to move. The access key will be described below.

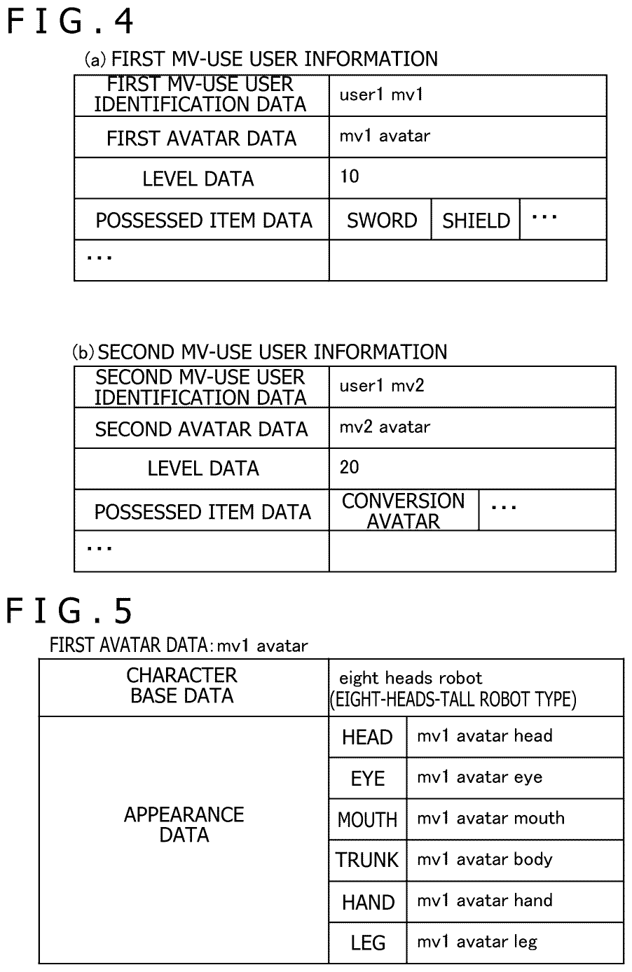

The terminal-use user information storage section 306 stores user information that is required when each of the first virtual space providing program and the second virtual space providing program is executed. Specifically, the terminal-use user information storage section 306 stores, for example, first MV-use user information as illustrated in FIG. 4(a), and second MV-use user information as illustrated in FIG. 4(b).

The first MV-use user information is user information that is required when the first virtual space providing program is executed. The first MV-use user information includes, for example, first MV-use user identification data, the first avatar data, level data, and possessed item data.

The first MV-use user identification data is information for uniquely identifying the user who executes the first virtual space providing program. Specifically, the first MV-use user identification data is, for example, “user1 mv1.” In addition, in the case where another user terminal 106 stores first MV-use user identification data, a different piece of first MV-use user identification data is stored therein.

The first avatar data includes character base data including bone information and motion information, and appearance data regarding each of portions of the first avatar. Specifically, for example, the first avatar data associated with the first MV-use user identification data, “user1 mv1,” is “mv1 avatar.”

The bone information is, for example, data related to an internal structure that serves as a basis when a motion is defined in three-dimensional computer graphics. The bone information is information representing a skeletal structure including bones and joints each having a prescribed thickness and size like a skeletal structure in a human body or the like. The motion information is information for defining motions of joints corresponding to joints and the like in the human body, and bones positioned between the joints and corresponding to bones in the human body.

In the present embodiment, a plurality of types of character base data have been set in advance separately for each of the virtual space providing programs. For example, a plurality of pieces of character base data, including “human,” which is character base data for a human type, “dog,” which is character base data for a dog type, and “eight heads robot,” which is character base data for an eight-heads-tall robot type, have been set for the first virtual space providing program.

The appearance data is data related to surface geometry and texture in the three-dimensional computer graphics. The appearance data is, for example, data corresponding to the geometry, color, and pattern of a skin or the like in the human body. The appearance data includes geometry data representing a set of voxels or the like located on a surface of each portion, and representing position information regarding each voxel. In addition, the appearance data includes texture data, which is color information regarding the voxels located on the surface of each portion. The geometry data may be data that specifies a surface geometry with a set of surfaces each being a region surrounded by three or more sides, each side being formed by joining vertexes on the basis of data related to vertexes and a mode of connecting the vertexes. In addition, the texture data may be information regarding color represented on such surfaces.

In the present embodiment, appearance data regarding a plurality of portions set in advance so as to be associated with each piece of character base data has been set. For example, FIG. 5 is a diagram illustrating character base data and appearance data included in the first avatar data, “mv1 avatar.” As illustrated in FIG. 5, in the first virtual space providing program, pieces of appearance data related to a head, an eye, a mouth, a trunk, a hand, and a leg have been set so as to be associated with “eight heads robot,” which is the character base data for the eight-heads-tall robot type.

The appearance data regarding each portion is set as a result of an operation being performed by the user on the input device 210. Specifically, for example, when the first virtual space providing program is executed for the first time, a list of appearances for each portion (a generally-called avatar creation screen) is displayed on the display device 208. An appearance selected by the user from the list of appearances for each portion is set as appearance data regarding that portion. In addition, the appearance data regarding each portion may be changed when the first virtual space providing program is put into operation a second time or later (that is, while the game is being executed).

As illustrated in FIG. 5, the first avatar data, “mv1 avatar,” includes the character base data, “eight heads robot,” for the eight-heads-tall robot type. The character base data, “eight heads robot,” represents a skeletal structure of the eight-heads-tall robot type, which has been set according to the first virtual space provided by the first virtual space providing program.

In addition, the first avatar data, “mv1 avatar,” includes the following pieces of data: “mv1 avatar head,” which is associated with a head portion; “mv1 avatar eye,” which is associated with an eye portion; “mv1 avatar mouth,” which is associated with a mouth portion; “mv1 avatar body,” which is associated with a trunk portion; “mv1 avatar hand,” which is associated with a hand (including an arm) portion; and “mv1 avatar leg,” which is associated with a leg portion.

The appearance data, “mv1 avatar head,” is, for example, data representing a form of the entire head portion with horns projecting from regions of both ears, and the color and pattern of the head portion excluding the eyes and the mouth. The appearance data, “mv1 avatar eye,” is, for example, data representing a form and color of a quadrilateral eye. The appearance data, “mv1 avatar mouth,” is, for example, data representing a form and color of a mouth being black and quadrilateral. The appearance data, “mv1 avatar body,” is, for example, data representing a form and color of a trunk of a robot with a V-shaped black pattern extending from a chest region to an abdominal region. The appearance data, “mv1 avatar hand,” is, for example, data representing a form and color of both arms of a robot, each arm having an expanded forearm portion with an N-shaped black pattern applied thereto. The appearance data, “mv1 avatar leg,” is, for example, data representing a form and color of both legs of a robot, each leg being white except for a black pattern extending from a tiptoe to a heel.

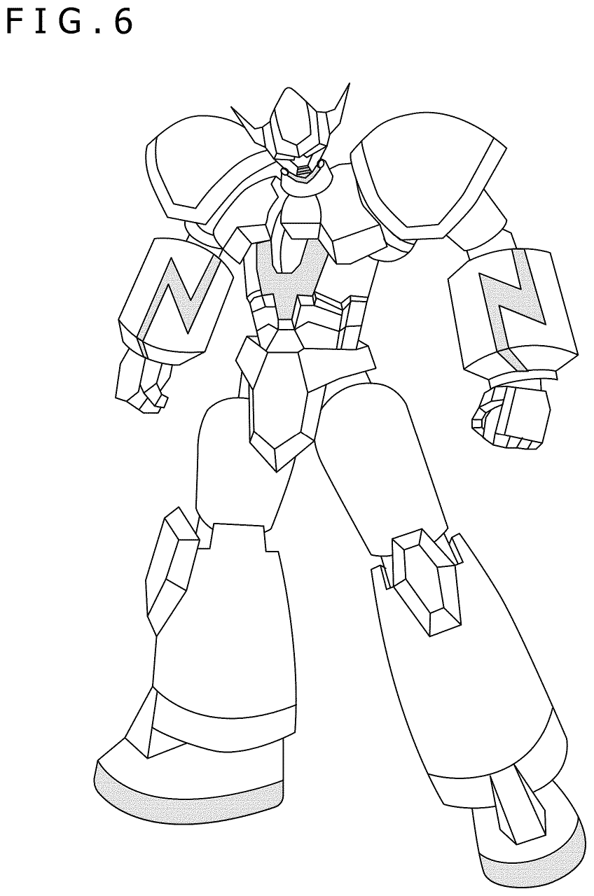

FIG. 6 is a diagram illustrating the appearance of the first avatar generated on the basis of the first avatar data, “mv1 avatar.” The first avatar has an appearance of a robot that is approximately eight heads tall, since the first avatar is generated on the basis of the character base data, “eight heads robot.” In addition, each portion of the first avatar is generated on the basis of the appearance data regarding that portion in FIG. 5, and is synthesized into a corresponding portion of the skeletal structure generated on the basis of the character base data.

The level data is an indicator representing the strength of a character that is operated by the user within the game which the virtual space providing program causes to progress. The level data included in the first MV-use user information is, for example, “10.”

The possessed item data is data indicating an item possessed by the character that is operated by the user within the game which the virtual space providing program causes to progress. For example, the possessed item data included in the first MV-use user information illustrated in FIG. 4(a) includes “sword” and “shield.” The possessed item data is used while the game is caused to progress.

The second MV-use user information illustrated in FIG. 4(b) is user information that is required when the second virtual space providing program is executed. The second MV-use user information includes, for example, second MV-use user identification data, the second avatar data, level data, and possessed item data. For example, the second avatar data includes character base data including bone information and motion information, and appearance data regarding each of portions of the second avatar. The second MV-use user information includes second MV-use user identification data, “user1 mv2,” second avatar data, “mv2 avatar,” and level data, “20.” The possessed item data included in the second MV-use user information will be described below.

Although the present embodiment is described with reference to an example case where the types of data included in the first MV-use user information are identical to the types of data included in the second MV-use user information, the types of data may be different therebetween. Also note that another type of data which has not been mentioned above may be included in each piece of user information.

The conversion request section 308 generates a conversion request signal for requesting conversion from the first avatar to the second avatar on the basis of an instruction from the user. Specifically, the case where the user desires to use the first avatar, which the user is moving in the first virtual space (hereinafter referred to also as a source virtual space), in the second virtual space (hereinafter referred to also as a destination virtual space) as well will be described below. As a result of a given operation being performed by the user on the input device 210, the first virtual space providing program performs a display for prompting the user to confirm whether or not to perform the conversion from the first avatar to the second avatar. When the user has performed, on the input device 210, an operation indicating that the conversion is to be performed, the conversion request section 308 generates the conversion request signal for requesting the conversion from the first avatar to the second avatar. The conversion request signal includes user identification information, and information indicating the source and destination virtual spaces. The conversion request section 308 transmits the generated conversion request signal to the management server 108.

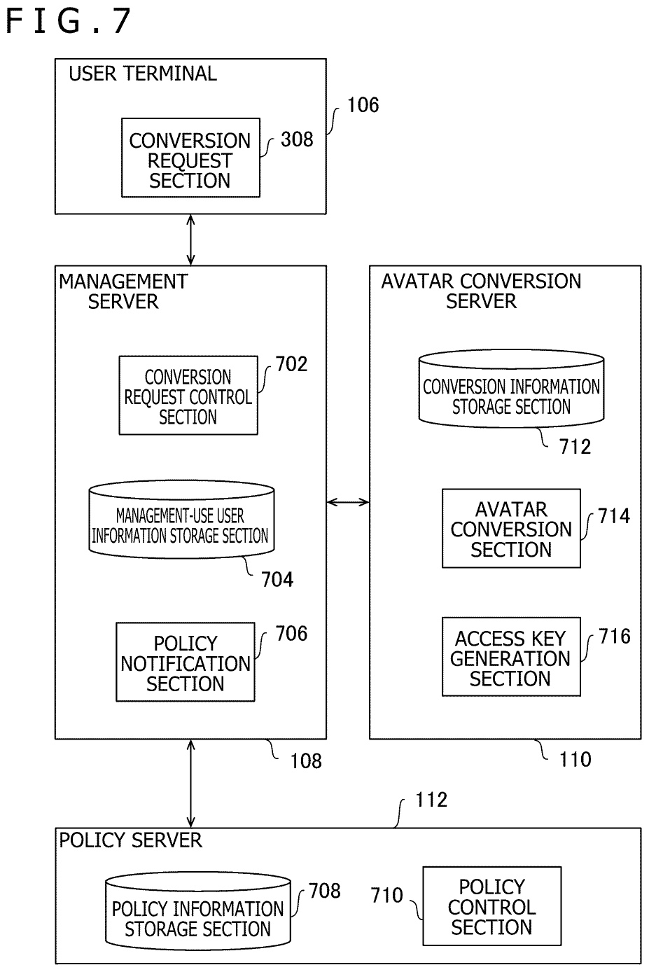

Next, functions of each of the management server 108, the policy server 112, and the avatar conversion server 110 will be described below. FIG. 7 represents a functional block diagram of each of the management server 108, the policy server 112, and the avatar conversion server 110. The management server 108 includes a conversion request control section 702, a management-use user information storage section 704, and a policy notification section 706.

Once the conversion request signal is acquired, the conversion request control section 702 controls an operation of the management server 108 which is related to avatar conversion. Specifically, for example, once the conversion request signal is acquired, the conversion request control section 702 executes an API (Application Programming Interface) for enabling the management server 108 to transmit and receive data to and from each of the user terminal 106, the policy server 112, and the avatar conversion server 110. In addition, the conversion request control section 702 transmits a signal for requesting transmission of policy information from the policy server 112. Further, when a signal indicating that the user agrees to policies has been acquired from the user terminal 106, the conversion request control section 702 transmits, to the avatar conversion server 110, a signal indicating a request for avatar conversion.

The management-use user information storage section 704 stores information related to the user. Specifically, the management-use user information storage section 704 stores account information, such as a login ID for identifying the user, and a password.

The policy notification section 706 notifies the user terminal 106 of the policy information acquired from the policy server 112.

The policy server 112 includes a policy information storage section 708 and a policy control section 710. The policy information storage section 708 stores policy information to be notified to the user when avatar conversion is performed. Specifically, for example, the policy information includes information indicating whether or not a user different from a user who has issued an instruction to perform conversion is permitted to copy a converted avatar (e.g., the second in the destination virtual space (e.g., the second virtual space). In addition, the policy information includes information indicating whether or not modification of appearance is permitted when the first avatar is converted to the second avatar. Moreover, the policy information includes information indicating whether or not storage of a conversion result in the management-use user information storage section 704 is permitted. The policy information may include information related to another policy.

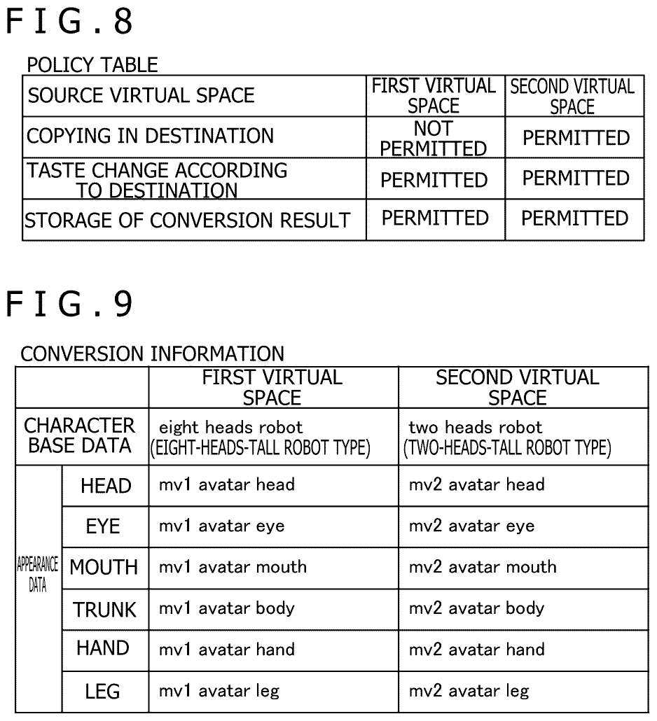

FIG. 8 is a diagram illustrating an example of a policy table including a plurality of pieces of policy information stored in the policy information storage section 708. The policy table includes one or a plurality of pieces of policy information for each source virtual space. In the example illustrated in FIG. 8, copying of the converted avatar in the destination virtual space is not permitted in the case where the source virtual space is the first virtual space. Meanwhile, in the case where the source virtual space is the first virtual space, modification of appearance according to the destination virtual space and storage of the conversion result in the management-use user information storage section 704 are permitted. In addition, in the case where the source virtual space is the second virtual space, all of the above is permitted.

The policy control section 710 controls an operation of the policy server 112 which is related to policy notification. Specifically, for example, the policy control section 710 first acquires, from the management server 108, the signal for requesting the transmission of policy information. This signal includes at least information indicating the source virtual space (e.g., the first virtual space). On the basis of the information indicating the source virtual space included in the acquired signal, the policy control section 710 selects policy information related to that virtual space included in the policy table. Further, the policy control section 710 transmits the selected policy information to the management server 108. Then, the policy notification section 706 transmits the acquired policy information to the user terminal 106.

The avatar conversion server 110 includes a conversion information storage section 712, an avatar conversion section 714, and an access key generation section 716. When an avatar placed in one virtual space is converted to an avatar placed in another virtual space, the conversion information storage section 712 stores previously set conversion information regarding avatar data of the avatar in the one virtual space and avatar data of the avatar in the other virtual space. For example, the conversion information storage section 712 stores previously set conversion information regarding avatar data of an avatar placed in the first virtual space and avatar data of an avatar placed in the second virtual space. Specifically, the conversion information is information indicating previously set correspondences between the character base data and the appearance data regarding each portion included in the first avatar data and the character base data and the appearance data regarding each portion included in the second avatar data.

FIG. 9 represents an example illustrating conversion information regarding the first virtual space and the second virtual space. The conversion information illustrated in FIG. 9 is information indicating correspondences between the character base data and the appearance data regarding the first avatar placed in the first virtual space and the character base data and the appearance data regarding the second avatar placed in the second virtual space.

Upon acquisition of the signal indicating a request for avatar conversion, the avatar conversion section 714 acquires, from the user terminal 106, the avatar data regarding the avatar placed in the source virtual space. Then, the avatar conversion section 714 generates, from this avatar data, avatar data regarding the avatar to be placed in the destination virtual space on the basis of the conversion information stored in the conversion information storage section 712. For example, in the case where the first avatar placed in the first virtual space is converted to the second avatar placed in the second virtual space, the avatar conversion section 714 first acquires a signal indicating a request for the conversion from the first avatar to the second avatar. Further, the avatar conversion section 714 acquires the first avatar data from the user terminal 106, and generates the second avatar data from the first avatar data on the basis of the conversion information stored in the conversion information storage section 712. The generated second avatar data is transmitted to the management server 108, and is temporarily stored in the management-use user information storage section 704 so as to be associated with account information of the user who has made the request for the avatar conversion.

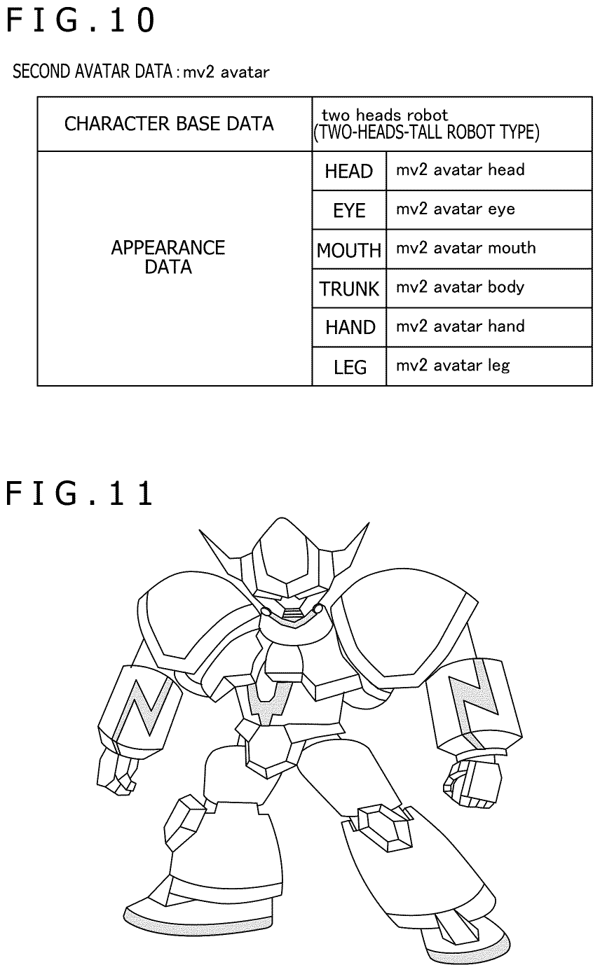

Second avatar data illustrated in FIG. 10 is the second avatar data, “mv2 avatar,” which the avatar conversion section 714 has generated on the basis of the first avatar data illustrated in FIG. 5 and the conversion information illustrated in FIG. 9.

As described above, in the present embodiment, a plurality of types of character base data have been set in advance separately for each of the virtual space providing programs. For example, a plurality of pieces of character base data, including “monkey,” which is character base data for a monkey type, “cat,” which is character base data for a cat type, and “two heads robot,” which is character base data for a two-heads-tall robot type, have been set for the second virtual space providing program.

The second avatar data, “mv2 avatar,” includes the character base data, “two heads robot.” The character base data, “two heads robot,” represents a skeletal structure of the two-heads-tall robot type, which has been set according to the second virtual space provided by the second virtual space providing program.

In addition, the second avatar data, “mv2 avatar,” includes the following pieces of data: “mv2 avatar head,” which is associated with a head portion; “mv2 avatar eye,” which is associated with an eye portion; “mv2 avatar mouth,” which is associated with a mouth portion; “mv2 avatar body,” which is associated with a trunk portion; “mv2 avatar hand,” which is associated with a hand (including an arm) portion; and “mv2 avatar leg,” which is associated with a leg portion. Appearance data regarding each of the portions is data regarding the appearance of that portion of the first avatar illustrated in FIG. 6 converted into an anime style according to the second virtual space.

FIG. 11 is a diagram illustrating the appearance of the second avatar generated on the basis of the second avatar data, “mv2 avatar.” The second avatar has an appearance of a robot that is approximately two heads tall, since the second avatar is generated on the basis of the character base data, “two heads robot.” In addition, each portion of the second avatar is generated on the basis of the appearance data regarding that portion in FIG. 10, and is synthesized into a corresponding portion of the skeletal structure generated on the basis of the character base data.

Once the avatar conversion section 714 generates the avatar data, the access key generation section 716 generates an access key associated with the converted avatar. In the example described above, once the avatar conversion section 714 generates the second avatar data from the first avatar data, the access key generation section 716 generates an access key associated with the second avatar data. The access key is, for example, a token representing a right to access the converted second avatar. The generated access key is transmitted to the user terminal 106 through the management server 108. Further, the access key is stored as possessed item data so as to be associated with the user information including the avatar data related to the converted avatar. As a result, the second MV-use user information includes possessed item data, “conversion avatar,” as illustrated in FIG. 4(b).

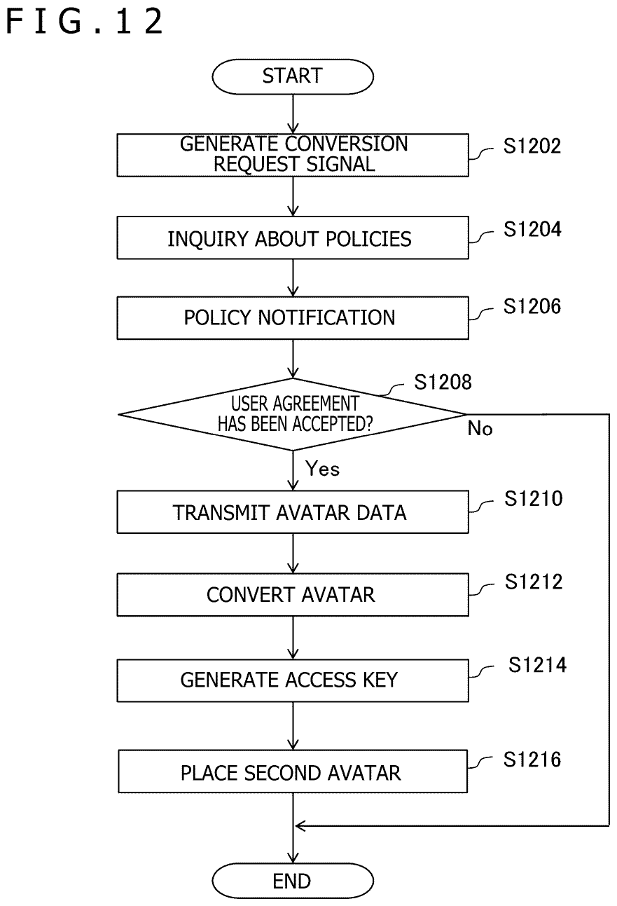

Next, with reference to a flowchart of FIG. 12, a procedure that is performed by the avatar conversion system 100 when the first avatar placed in the first virtual space is converted to the second avatar placed in the second virtual space will be described below. It is assumed that the user terminal 106 has already executed the first virtual space providing program, and the first avatar has already been placed in the first virtual space.

First, the conversion request section 308 generates the conversion request signal for requesting the conversion from the first avatar to the second avatar on the basis of the instruction from the user (S1202). Specifically, for example, the first avatar having the appearance illustrated in FIG. 6 has been placed in the first virtual space. The user operates the input device 210 and thereby causes the first avatar to move to a predetermined position in the first virtual space. The predetermined position is, for example, a portal placed in the first virtual space as a gateway between the first virtual space and another virtual space. Such a portal may be provided for each of destination virtual spaces (for example, a portal that joins the first virtual space and the second virtual space). Alternatively, the user may operate the input device 210 and thereby enter a command indicating that the avatar is to move from the first virtual space into the second virtual space. When this operation has been performed, the conversion request section 308 generates the conversion request signal for requesting the conversion from the first avatar to the second avatar, and transmits the conversion request signal to the management server 108. Note that the conversion request signal includes the account information of the user, and the information indicating the source and destination virtual spaces.

Next, the management server 108 makes an inquiry about policies (S1204). Specifically, when the conversion request signal has been acquired, the conversion request control section 702 executes the above-mentioned API. Thereafter, the management server 108 uses the API to transmit and receive data to and from each of the user terminal 106, the policy server 112, and the avatar conversion server 110. Then, the conversion request control section 702 transmits to the policy server 112 the signal for requesting transmission of policy information. This signal includes information indicating that the source virtual space is the first virtual space. After acquiring this signal, the policy server 112 refers to the policy table as illustrated in FIG. 8, and transmits the policy information related to the first virtual space to the management server 108.

Next, the policy notification section 706 performs policy notification (S1206). Specifically, when the policy information has been acquired, the policy notification section 706 transmits the acquired policy information to the user terminal 106. On the user terminal 106, which has acquired the policy information, three policies indicating that the converted avatar will not be copied, that the appearance will be modified as a result of the avatar conversion, and that the conversion result will be stored in the management-use user information storage section 704, and a screen for inputting an agreement or disagreement about these policies, are displayed.

Next, in the case where the user has agreed to the policies by operating the input device 210 at S1208, control proceeds to S1210, while in the case where the user does not agree thereto, the present flow is finished without the avatar conversion being performed. In the case where the avatar conversion is not performed, a message indicative thereof may be displayed on the user terminal 106.

Next, the user terminal 106 transmits the avatar data (S1210). Specifically, the user terminal 106 transmits the first avatar data to the management server 108. Further, the management server 108 transmits, to the avatar conversion server 110, the first avatar data, the information indicating that the source virtual space is the first virtual space, and information indicating that the destination virtual space is the second virtual space.

Next, the avatar conversion section 714 performs the avatar conversion (S1212). Specifically, since the source virtual space is the first virtual space and the destination virtual space is the second virtual space, the avatar conversion section 714 converts the first avatar data to the second avatar data with reference to the conversion information illustrated in FIG. 9. The generated second avatar data is transmitted to the management server 108 and is temporarily stored in the management-use user information storage section 704 so as to be associated with the account information of the user who has made the request for the avatar conversion.

Next, the access key generation section 716 generates the access key associated with the converted avatar (S1214). Specifically, once the avatar conversion section 714 generates the second avatar data, the access key generation section 716 generates the access key associated with the second avatar data. The generated access key is transmitted to the user terminal 106 through the management server 108. Further, the access key is stored as possessed item data so as to be associated with the user information including the avatar data related to the avatar in the destination. As a result, the second MV-use user information includes the possessed item data, “conversion avatar,” as illustrated in FIG. 4(b).

Next, the avatar based on the converted avatar data is placed in the destination virtual space (S1216). Specifically, for example, the user operates the input device 210 and thereby stops executing the first virtual space providing program, and executes the second virtual space providing program. At this point in time, the second avatar placed in the second virtual space is an avatar before being subjected to the avatar conversion. That is, the second avatar is an avatar that is generated on the basis of the second avatar data stored in the terminal-use user information storage section 306 before the avatar conversion is performed.

Here, at S1214, “conversion avatar,” stored as the possessed item data in the second MV-use user information, is in a state of being usable in the second virtual space. Once the user operates the input device 210 to use the possessed item, “conversion avatar,” the user terminal 106 transmits, to the management server 108, a signal indicating that an access has been made to the access key with the signal being associated with the account information of the user who has made the request for the avatar conversion. After acquiring this signal, the management server 108 transmits the temporarily stored second avatar data to the user terminal 106 on the basis of the account information of the user. Then, once the user terminal 106 acquires the second avatar data, the second avatar is generated on the basis of the second avatar data acquired from the avatar conversion server 110 in response to an input of the access key by the user. At this point in time, the second avatar has, for example, the appearance illustrated in FIG. 11.

As described above, the second virtual space providing program execution section 304 acquires the second avatar data from the avatar conversion server 110 in response to the input of the access key by the user. The second virtual space providing program execution section 304 is able to cause the game to progress with the second avatar generated on the basis of the acquired second avatar data being placed therein. In addition, the first avatar generated according to the first virtual space having the realistic world view can be converted according to the second virtual space having the anime-style world view. Accordingly, the user is able to carry an avatar having a favorite appearance into various virtual spaces, and operate the avatar therein with the avatar being arranged according to the world view of each virtual space.

The above-described embodiment is an example of the present invention and can be modified as appropriate. For example, although the hardware configuration in which the management server 108, the policy server 112, and the avatar conversion server 110 included in the avatar conversion system 100 are separate from each other has been described above, a configuration in which a single server has the functions of the management server 108, the policy server 112, and the avatar conversion server 110 may be adopted.

Also, although the case where the avatar control section, the virtual space management section, and the rendering section are included in the user terminal 106 has been described above, the functions of these sections may be included in the corresponding MV server. In this case, operation signals indicative of operations performed on the input device 210 are transmitted from the user terminal 106 to the MV server. Meanwhile, the MV server includes the functions of the avatar control section, the virtual space management section, and the rendering section, and controls the motion of the avatar placed in the virtual space on the basis of the operation signals. In addition, the MV server may be configured to transmit image signals to the user terminal 106 (generally-called streaming distribution).

1. An avatar conversion system comprising:
a user terminal including
a first virtual space providing program execution section that uses a first avatar generated on a basis of first avatar data in a first virtual space,
a second virtual space providing program execution section that uses a second avatar generated on a basis of second avatar data in a second virtual space, and
a conversion request section that generates a conversion request signal for requesting conversion from the first avatar to the second avatar on a basis of an instruction from a user; and
an avatar conversion server including
a conversion information storage section that stores previously set conversion information regarding the first avatar data and the second avatar data, and
an avatar conversion section that, when the conversion request signal has been acquired, acquires the first avatar data from the user terminal, and generates the second avatar data from the first avatar data on a basis of the conversion information stored in the conversion information storage section, wherein
the second avatar is generated on a basis of the second avatar data acquired from the avatar conversion server in accordance with a user operation.

2. The avatar conversion system according to claim 1, further comprising:
an access key generation section that generates an access key associated with the second avatar when the avatar conversion section has generated the second avatar data from the first avatar data, wherein
the second virtual space providing program execution section acquires the second avatar data from the avatar conversion server in response to an input of the access key by the user.

3. The avatar conversion system according to claim 1, further comprising:
a management server including a policy notification section that notifies the user terminal of policy information related to the conversion from the first avatar to the second avatar when the conversion request signal has been acquired.

4. The avatar conversion system according to claim 3, wherein the policy information includes information indicating whether or not modification of appearance is permitted when the first avatar is converted to the second avatar.

5. The avatar conversion system according to claim 3, wherein the policy information includes information indicating whether or not a user different from the user who has issued the instruction is permitted to copy the second avatar in the second virtual space.

6. The avatar conversion system according to claim 1, wherein
each of the first avatar data and the second avatar data includes character base data including bone information and motion information thereof, and appearance data regarding each of portions of an avatar, and
the conversion information is information indicating previously set correspondences between the character base data and the appearance data regarding each portion included in the first avatar data and the character base data and the appearance data regarding each portion included in the second avatar data.

7. The avatar conversion system according to claim 1, wherein
the first virtual space providing program execution section is a program for executing a game with the first avatar being caused to move in the first virtual space, and
the second virtual space providing program execution section is a program for executing a game with the second avatar being caused to move in the second virtual space.

8. An avatar conversion server that performs conversion of an avatar when a conversion request signal has been acquired from a user terminal including
a first virtual space providing program execution section that uses a first avatar generated on a basis of first avatar data in a first virtual space,
a second virtual space providing program execution section that uses a second avatar generated on a basis of second avatar data in a second virtual space, and
a conversion request section that generates a conversion request signal for requesting conversion from the first avatar to the second avatar on a basis of an instruction from a user, the avatar conversion server comprising:
a conversion information storage section that stores previously set conversion information regarding the first avatar data and the second avatar data; and
an avatar conversion section that, when the conversion request signal has been acquired, acquires the first avatar data from the user terminal, and generates the second avatar data from the first avatar data on a basis of the conversion information stored in the conversion information storage section, wherein
the second avatar is generated on a basis of the second avatar data acquired from the avatar conversion server in accordance with a user operation.

9. An avatar conversion program for a computer, comprising:
acquiring, from a user terminal including a first virtual space providing program execution section that uses a first avatar generated on a basis of first avatar data in a first virtual space, a second virtual space providing program execution section that uses a second avatar generated on a basis of second avatar data in a second virtual space, and a conversion request section that generates a conversion request signal for requesting conversion from the first avatar to the second avatar on a basis of an instruction from a user, the conversion request signal;
by an avatar conversion section, acquiring the first avatar data from the user terminal when the conversion request signal has been acquired; and
by the avatar conversion section, generating the second avatar data from the first avatar data on a basis of previously set conversion information regarding the first avatar data and the second avatar data stored in the conversion information, wherein
the second avatar is generated on a basis of the second avatar data in accordance with a user operation.

10. An avatar conversion method comprising:
acquiring, from a user terminal including a first virtual space providing program execution section that uses a first avatar generated on a basis of first avatar data in a first virtual space, a second virtual space providing program execution section that uses a second avatar generated on a basis of second avatar data in a second virtual space, and a conversion request section that generates a conversion request signal for requesting conversion from the first avatar to the second avatar on a basis of an instruction from a user, the conversion request signal;
acquiring the first avatar data from the user terminal when the conversion request signal has been acquired; and
generating the second avatar data from the first avatar data on a basis of previously set conversion information regarding the first avatar data and the second avatar data stored in a conversion information storage section that stores the conversion information, wherein
the second avatar is generated on a basis of the second avatar data generated in the generating in accordance with a user operation.
